(19) United States
(12) Patent Application Publication
(10) Pub. No.: US 2014/0156386 A1
(43) Pub. Date: Jun. 5, 2014

(54) SYSTEM AND METHOD FOR RECRUITING MOBILE APP USERS TO PARTICIPATE IN SURVEYS

(71) Applicant: Michael WILLIAMS, Edmonton (CA)

(72) Inventor: Michael WILLIAMS, Edmonton (CA)

(73) Assignee: ADVANIS INC., Edmonton (CA)

(21) Appl. No.: 14/095,673

(22) Filed: Dec. 3, 2013

Related U.S. Application Data
(60) Provisional application No. 61/733,219, filed on Dec. 4, 2012.
(60) Provisional application No. 61/735,389, filed on Dec. 10, 2012.

(51) Int. Cl. G06Q 30/02

(52) U.S. Cl. CPC G06Q 30/0203
USPC 705/14.44

(57) ABSTRACT

A method for recruiting a mobile app user to participate in a survey includes the steps of receiving a user id from the mobile device app, transmitting notification information to the mobile device, wherein the notification information is displayable by the mobile device to present an option of participating or declining participation in the survey, receiving participation information that reflects a participation state of the survey, and updating a non-recruitment period persistently stored in association with the user id in accordance with a rules database depending on the participation information.

### CROSS REFERENCE TO RELATED APPLICATION

This application claims the priority benefit of U.S. Provisional Application No. 61/733,219 filed on Dec. 4, 2012, and U.S. Provisional Application No. 61/735,389 filed on Dec. 10, 2012, both entitled “System and Method for Recruiting Mobile Device Users to Participate in Consumer Surveys”, the entire contents of both which are incorporated herein by reference.

### FIELD OF THE INVENTION

The present invention relates to a system and method for recruiting mobile app users to participate in surveys.

### BACKGROUND

Market research surveys are widely regarded as an effective tool for businesses to obtain information about their brand and services. Although randomly conducted surveys may be appropriate for survey topics that are relevant to larger swaths of the population, surveys are considered more effective and reliable if directed at particular segments of the general population that are most relevant to the survey topic. Surveys are typically conducted by telephone interview, in person interviews, small focus groups, and now increasingly email and web-based surveys. Mobile device users, however, have been underrepresented because of practical limitations and technical difficulties associated with conducting surveys using mobile devices.

Conventionally, survey participants using mobile devices are recruited using by embedding a survey in a mobile app installed on the mobile device. These apps do not consider the mobile app user's survey participation history or customer relationship history in deciding whether or not to recruit the user for the survey. As a consequence, these apps may attempt to recruit a mobile app user who has declined participation in the survey or recently completed the survey, at the risk of annoying the user. Also, these apps cannot recruit a mobile app user based on the user's recent visit to a store or purchase of a product, so as to obtain timely information about the user's shopping experience. Further, these apps have complicated embedded survey and recruitment algorithms that make them difficult to implement and update, and increase the risk of security flaws, which is of particular concern in apps related to financial products and services such as banking.

Accordingly, there is a need in the art for systems and methods for recruiting mobile app users to participate in surveys that overcome the limitations of conventional systems and methods in the art, and encourage timely participation of mobile app users in surveys.

### SUMMARY OF THE INVENTION

In one aspect, the invention may comprise a method for recruiting a mobile app user to participate in a survey, the method implemented by a recruitment server in communication via a network with a mobile device having an app, the method comprising the steps of:
(a) receiving a user id from the mobile device app;
(b) transmitting notification information to the mobile device, wherein the notification information is displayable by the mobile device to present an option of participating or declining participation in the survey;
(c) receiving participation information that reflects a participation state of the survey; and
(d) updating a non-recruitment period persistently stored in association with the user id in accordance with a rules database depending on the participation information, wherein the non-recruitment period defines a time period within which the server system refrains from transmitting further notification information to the mobile device.

In one embodiment, the method may further comprise the step of determining whether a non-recruitment period is expired or unexpired; and wherein the performance of steps (b) to (d) is contingent on the non-recruitment period being expired. If it is determined that the non-recruitment period is unexpired, the method may further comprise the step of automatically re-performing step (b) to (d) of claim 1 at a future check date.

The method of claim 1 further comprising the steps of: receiving from the mobile device a user-specified time preference for receiving notification information; and modifying the non-recruitment period based on the time preference.

In one embodiment, the method may further comprise the steps of: receiving user-specified criteria for survey types; and determining whether the survey satisfies the criteria; and wherein the performance of steps (b) to (d) of claim 1 is contingent on the survey satisfying the criteria.

In one embodiment, the method may further comprise the steps of: receiving interaction information reflecting the mobile app user's interaction with a vendor; and, in response to the interaction information, modifying the non-recruitment period or transmitting notification information to the mobile device.

In another aspect, the invention may comprise a recruitment server system that provides functionality for recruiting a mobile app user to participate in a survey, the recruitment server system capable of communicating via a network with a mobile device having an app, and comprising:
(a) at least one processor; and
(b) at least one memory component operatively connected to the at least one processor and storing a set of instructions executable by the at least one processor to implement a method as defined by any one of claims 1 to 6.

In another aspect, the invention may comprise a memory comprising a recording medium having recorded thereon instructions, which when executed by a processor of a recruitment server system in communication via a network with a mobile device having an app, causes the server system to carry out a method as defined in the claims.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 is a schematic representation of one embodiment of the method of the present invention.

FIG. 2 is a schematic representation of one embodiment of the system of the present invention in communication via the Internet with mobile devices.

### DETAILED DESCRIPTION OF PREFERRED EMBODIMENTS

The present invention relates to a system and method for recruiting mobile app users to participate in a survey. Any term or expression not expressly defined herein shall have its commonly accepted definition understood by those skilled in the art.

As used herein, a “mobile device” shall mean a small, portable (handheld or wearable) computing device with wireless communication capabilities, such as cellular telephony, data connectivity, WLAN (such as Wifi or WiMax), Bluetooth™ and the like. Typical mobile devices include smartphones and tablet computers. As used herein, a “mobile app user” shall mean a person who uses a mobile device on which an app has been installed. As used herein, an “app” shall mean application software for mobile devices, in which the software includes a survey module for prompting a mobile app user to participate in a survey, or querying if the mobile app user would like to participate in a survey. An app includes application software, whether installed by a mobile app user or that forms part of the mobile device's operating system software or system configuration software.

As used herein, a “survey” shall mean a method of research whereby a subject provides data in response to pre-determined prompts or questions, which data may be useful to a vendor, either individually or when aggregated with similar data from other subjects. Survey methodology is a well-known field, and the nature of the surveys and survey methodology is not part of the present invention. As used herein, a “vendor” is a person merchant who is the intended beneficiary of the data acquired through a survey. As non-limiting examples: a vendor may be a bank and the app comprises mobile banking software that allows the mobile app user to access internet banking from the mobile device; a vendor may be a manufacturer of a mobile device, and the app may comprise system configuration software; or, a vendor may be a loyalty plan operator, and the app may comprise software which allows access to the mobile app user's loyalty plan account.

As used herein, a “recruitment server” shall mean a computer device that includes at least one memory component operatively connected to at least one processor, and that is capable of communicating with a mobile device via a network. The least one memory component stores a set of instructions that are executable by the at least one processor to implement the method of the present invention. In one embodiment, a recruitment server system may include a general purpose computer. In one embodiment, the network includes the Internet.

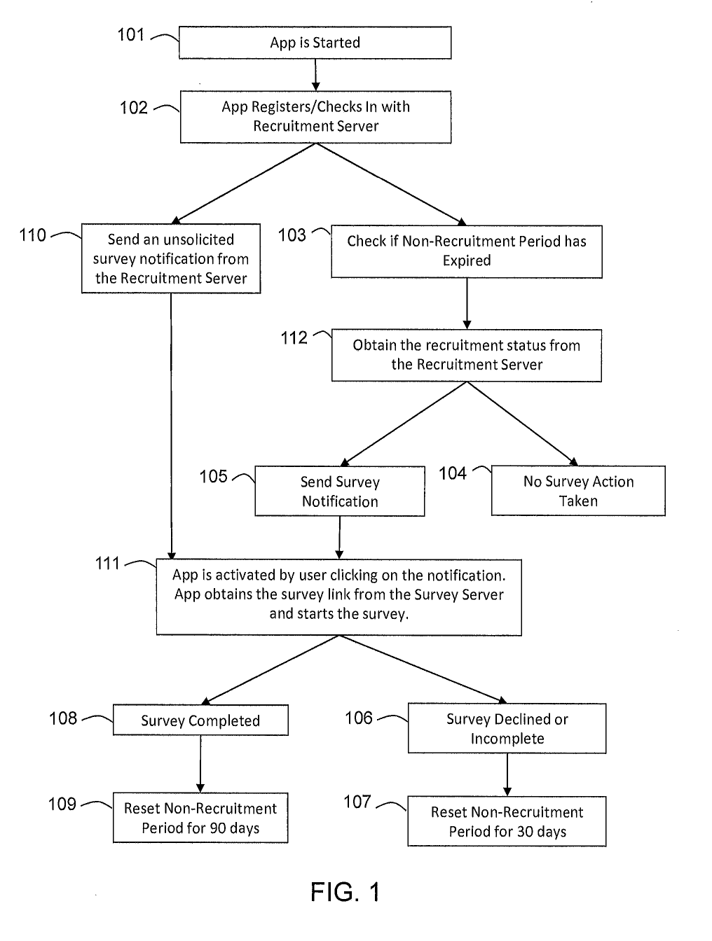

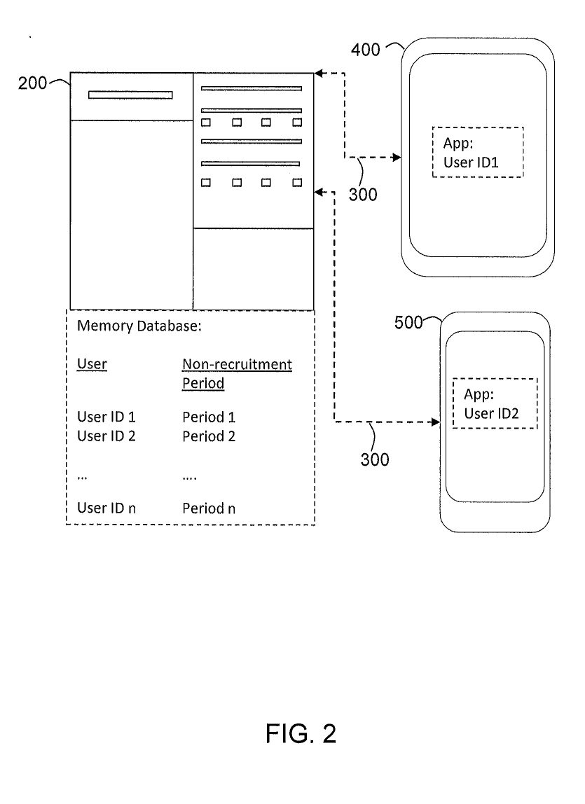

In general, the present invention provides a method and a system for recruiting a mobile app user to participate in a survey. FIG. 1 provides a schematic representation of one embodiment of the method, while FIG. 2 shows a schematic representation of the recruitment server system (200) in communication via the Internet (300) with a first mobile device in the form of a tablet computer (400) and a second mobile device in the form of a smartphone (500). It will be understood that that recruitment server (200) may be in communication with as many mobile devices as there are potential survey participants.

Referring to FIG. 1, in one embodiment, the method begins with the mobile app user opening an app session on a mobile device (step 101). The app queries the recruitment server via the Internet to determine if the mobile device is registered with the recruitment. If the mobile device is not registered, the survey recruitment server assigns and stores a unique mobile device user identifier (a user id) and transmits it to the mobile device. The app stores the user id on the mobile device (step 102). The user id may then be used to “check in” the mobile device with the recruitment server upon subsequent open sessions of the app.

The recruitment server persistently stores the user id in association with a variety of information relevant to the mobile app user and recruitment. Minimally, this associated information includes a non-recruitment period which defines, directly or indirectly, a time period within which the recruitment server should refrain from attempting to recruit the mobile app user to participate in the survey. As non-limiting examples, the non-recruitment period may be set to a date that is a predetermined period of time after the last date the mobile app user participated in a survey, the last date an attempt was made to recruit the mobile app user, or the date of a particular interaction between the mobile app user and the vendor.

In one embodiment of the method, during an open session of the app, the app requests the recruitment server system to determine if a non-recruitment period is expired or unexpired (step 103), and the recruitment server system makes that determination (112) based on the stored non-recruitment period. If the non-recruitment period is unexpired, no survey action is presently taken (step 104). In one embodiment, the recruitment server may also transmit information to the app to set a future check date, at which time the app will again request the recruitment server to determine if a non-recruitment period is expired or unexpired.

Alternatively, if the non-recruitment period is expired, then the mobile app sends a request to the recruitment server over the Internet. This request contains the user id of the mobile device, a mobile app id, and any usage data that is relevant to the survey request. In response to the request, the recruitment server system transmits to the mobile device notification information that provides the mobile device user with options for participating or declining participation in the survey (step 105).

In one embodiment, the app itself displays the notification information. As a non-limiting example, the app may display the notification information as a prompt with “Accept” and “Decline” buttons. If the mobile app user selects the “Accept” button, the app is activated to launch a user interface on the app itself, or a web browser on the mobile device directed to a URL containing the survey information (step 111). In other embodiments, the app may direct the mobile device use to an interactive voice response system, a conversation with a live agent, or text messaging such as short message service (SMS). The app can direct the mobile device user to surveys hosted on any surveying system, including the app's own designated system or other vendor's system. In other embodiments, a notification service of the mobile device's operating system may be used to display the notification information.

In the above described embodiment, the decision of whether or not to recruit the mobile device user to participate in the survey is contingent, in whole or in part, on whether or not the non-recruitment period is expired at the time an open session of the app transmits a request to the recruitment server. In an alternative embodiment of the method, the recruitment server system may transmit notification information (step 110), without the app having an open session and without checking whether the non-recruitment period is expired or unexpired.

Irrespective of whether the mobile app user chooses to participate in a survey or declines participation in the survey, participation information is transmitted to the recruitment server. The participation information may be transmitted from either the mobile device or from another server that hosts the survey. The participation information reflects the completion state of the survey and is used to update the non-recruitment period in accordance with a rules database. The rules database may be customized to the vendor's preferences. By way of a non-limiting example, if the mobile app user declines participation in the survey, or if the mobile app user starts the survey but does not complete it (step 106), such participation information is stored by the recruitment server, and causes the recruitment server to update the non-recruitment period (step 107) to 30 days from the date the mobile app user declined participation in the survey or last responded to the survey. Alternatively, if the mobile app user completes the survey (step 108), such participation information is stored by the recruitment server and causes the recruitment server to update the non-recruitment period (step 109) to 90 days from the date the mobile app user completed the survey. In this manner, the method may be used to track the recruitment and survey participation patterns in an effort to minimize the impact of recruitment on the mobile app user.

In one embodiment, the app itself permits the mobile app user to customize preferences or criteria as to how the user is recruited and responds to the survey. For example, the app may permit the mobile app user to configure time-based preferences that are transmitted to the recruitment server and used to modify the non-recruitment periods designated by the system or to permanently prohibit survey recruitment. As another example, the app may permit the mobile app user to configure preferences relating to type of survey in regards to parameters such as response mode, topic, or length of the survey. All such customization information is stored on the recruitment server in association with the user id, rather than in the app itself, and can be used as additional criteria by the recruitment server to determine whether or not to transmit notification information to the mobile device.

In one embodiment, the recruitment process and operation of the app is enhanced by extrinsic information from the vendor. This information may be sourced from information gathered from a previous store visit, or any previous interaction between the vendor and the mobile app user. For example, if the mobile app user uses the app to make an online purchase of a product or access a particular service, information related to this interaction may be sent to the survey recruitment server. In response to receiving this information, the survey recruitment server may transmit notification information to the mobile device (step 110) or modify the non-recruitment period, in an effort to conduct a survey that is timely and relevant to the interaction between the mobile app user and the vendor.

One advantage of the present invention is that it requires relatively insignificant modification to existing apps to implement the invention. The only code required is code to call external web-based services such as the survey recruitment server or a server hosting the survey information, rather than including code libraries within the app. Sample code may be provided that shows how to call these services, but the use of this code would not be required, This allows app developers that are extremely concerned with security to incorporate this system, without adding delays for auditing of the code. Another advantage of the present invention is that once the app has been configured for the invention, the rules or parameters for recruitment and the links to the actual surveys can all be changed at the recruitment server or another external server, without further changes to the app.

As will be apparent to those skilled in the art, various modifications, adaptations and variations of the foregoing specific disclosure can be made without departing from the scope of the invention claimed herein.

What is claimed is:

2. A method for recruiting a mobile app user to participate in a survey, the method implemented by a recruitment server in communication via a network with a mobile device having an app, the method comprising the steps of:
(a) receiving a user id from the mobile device app;
(b) transmitting notification information to the mobile device, wherein the notification information is displayable by the mobile device to present an option of participating or declining participation in the survey;
(c) receiving participation information that reflects a participation state of the survey; and
(d) updating a non-recruitment period persistently stored in association with the user id in accordance with a rules database depending on the participation information, wherein the non-recruitment period defines a time period within which the server system refrains from transmitting further notification information to the mobile device.

3. The method of claim 1 further comprising the step of determining whether a non-recruitment period is expired or unexpired; and wherein the performance of steps (b) to (d) is contingent on the non-recruitment period being expired.

4. The method of claim 2 wherein, if it is determined that the non-recruitment period is unexpired, the method further comprises the step of automatically re-performing step (b) to (d) of claim 1 at a future check date.

5. The method of claim 1 further comprising the steps of: receiving from the mobile device a user-specified time preference for receiving notification information; and modifying the non-recruitment period based on the time preference.

6. The method of claim 1 further comprising the steps of: receiving user-specified criteria for a survey parameter; and determining whether the survey satisfies the criteria; and
wherein the performance of steps (b) to (d) of claim 1 is contingent on the survey satisfying the criteria.

7. The method of claim 1 further comprising the steps of: receiving interaction information reflecting the mobile app user's interaction with a vendor; and, in response to the interaction information, modifying the non-recruitment period or transmitting notification information to the mobile device.

8. A recruitment server system that provides functionality for recruiting a mobile app user to participate in a survey, the recruitment server system capable of communicating via a network with a mobile device having an app, and comprising:
(a) at least one processor; and
(b) at least one memory component operatively connected to the at least one processor and storing a set of instructions executable by the at least one processor to implement a method as defined by any one of claims 1 to 6.

9. A memory comprising a recording medium having recorded thereon instructions, which when executed by a processor of a recruitment server system in communication via a network with a mobile device having an app, causes the server system to carry out a method as defined by any one of claims 1 to 6.
